(19) United States
(12) Patent Application Publication
(10) Pub. No.: US 2016/0100558 A1
(43) Pub. Date: Apr. 14, 2016

(54) SHELLFISH DEPURATION

(71) Applicant: QUALITY PERSPECTIVE LTD, Camberley Surrey (GB)

(72) Inventor: Woodage Christopher, Camberley, Surrey (GB)

(73) Assignee: QUALITY PERSPECTIVE LTD, Camberley, Surrey (GB)

(21) Appl. No.: 14/892,594

(22) PCT Filed: May 22, 2014
(86) PCT No.: PCT/EP2014/060491

§ 371 Date: Nov. 20, 2015

(30) Foreign Application Priority Data
May 22, 2013 (GB) 1309216.8

(51) Int. Cl. A01K 61/00; A01K 63/04

(52) U.S. Cl. CPC A01K 61/002; A01K 61/005; A01K 63/04

(57) ABSTRACT

A method of depurating shellfish, by taking decontaminated seawater, uncontaminated seawater, brackish water or water with sufficient salinity to support shellfish, holding the shellfish and the water in a container (21), lagoon or other body of water separate from the sea, and allowing the shellfish to feed, for a sufficient time for the any viruses and bacteria to be expelled or deactivated. Shellfish feed in the form of active or inactive phytoplankton or other substance on which shellfish may feed may be added to the water.

The present invention relates to shellfish depuration, that is, the cleansing of various edible shellfish of the phylum mollusca, particularly, but not exclusively, oysters.

Various shellfish of the mollusc phylum have been eaten by humans since prehistoric times. Many edible shellfish, particularly those of the bivalvia class such as oysters, mussels, clams and scallops, are filter feeders, sifting the water they inhabit for suspended particles from which they derive their nutrition.

The finest shellfish in terms of quality and safety are those grown in seawater that is free from contamination. Such shellfish can be consumed safety with no need for post-harvesting purification.

However, if harmful viruses, bacteria or other microorganisms are present in the seawater they will be ingested by the shellfish and viruses are accumulated in their tissues.

Unfortunately, in the UK and most developed countries, the coastal water in which shellfish grow is contaminated by the effluent from sewage works, uncontrolled sewage discharges, agricultural run-off, etc (in this document “sewage borne” refers to contamination from all human and animal sources). Sewage contains very high levels of harmful microorganisms and the processes involved in sewage treatment have comparatively little effect on the level of bacteria and viruses. The same applies to shellfish harvesting areas in most developed countries.

As a result, the shellfish are likely to be contaminated with sewage-borne bacteria and viruses that can cause illness in consumers. Almost all shellfish harvesting areas in mainland Britain are classified as Class B waters because of such contamination.

The level of contamination is significant. Lowther et al (Investigation into the prevalence, distribution and levels of norovirus titre in oyster harvesting areas in the UK. CEFAS Laboratory project for UK Food Standards Agency, FSA project code FS235003 (P01009), August 2011) analysed 884 samples of oysters harvested from 39 sites around the UK over a period of 2 years. Most of these sites were Class B waters, although 2 were Class C. The average level of norovirus over a year was less than 100 RNA copies per gram of digestive diverticula but during the winter months the average rose to 500 RNA copies/g. Norovirus is accumulated within the digestive diverticulum of the oyster and, when oysters are analysed for the presence of norovirus, the digestive diverticulum is dissected out and analysed. The results are expressed per gram of digestive diverticulum. An oyster contains about 15 grams of meat, of which about 5% is digestive diverticulum.

A volunteer study by Teunis et al (Teunis et al, Norwalk virus: how infectious is it? Journal of Medical Virology 80: 1468-1476, 2008) showed that the minimum dose of norovirus required to cause illness in susceptible humans is 100 virus particles. A person eating a dozen oysters would exceed this dose if the oyster if the oysters were to contain more than 11 RNA copies per gram.

An analysis of oyster samples associated with human outbreaks of norovirus (Lowther et al, Comparison of norovirus RNA levels in outbreak-related oysters with background environmental levels. J. Food Prot. 75:389-93, 2012) showed that the average level of norovirus genome copies in outbreak associated samples was 1048 copies per gram with the lowest level associated with an outbreak being 152 copies per gram.

The above information from Teunis and Lowther indicates that oysters harvested in the UK during the winter are capable of causing outbreaks and that oysters harvested at any time of the year are capable of causing illness in susceptible individuals. This invention will reduce the level of norovirus to below that required to cause illness in susceptible people.

It is a legal requirement in the EC that shellfish harvested from these waters are treated by one of two methods before being placed on the market; depuration, in which the shellfish are held for a period in sterilised water, and relaying, in which shellfish are transported to another area of the sea that has been classified as relatively uncontaminated.

Depuration

In the UK, the minimum depuration criteria involve holding the shellfish for a minimum of 42 hours in tanks or shallow trays immersed in seawater that has been sterilised by the action of UV light (see e.g. ‘Guidance for inspection of shellfish purification systems for Local Food Authorities’ Local Authority Food Law Enforcement Branch, Version 2, July 2009, Food Standards Agency, Scotland). Sterilisation using ozone may be used as an alternative to UV. The water is continuously recirculated through the shellfish and UV source. Depuration is a costly process but its main disadvantage is that it is ineffective at removing sewage borne viruses from the shellfish and is not completely effective at removing sewage borne bacteria.

A number of researchers have investigated norovirus removal during conventional depuration (immersion in water sterilised by UV light). The effect of depuration on viruses is temperature dependent. No depletion of virus occurs below 10 C. Recent research has shown that, after depuration for 14 days at 16° C. in UV-treated seawater, 59% of the original level of norovirus was still present in the oysters, a 0.23 log reduction in 14 days. (Neish A, Investigative trials on the purification of oysters to identify ways of reducing norovirus, CEFAS contract report C5224, April 2013)

Depuration under normal conditions is 93% effective at removing bacterial contamination but has little or no effect on norovirus or other viruses.

Relaying

Relaying involves placing the oysters into suitable containers and replacing the shellfish into the sea in an area of water that is presumed to be clean. In the UK, this must be a Class A area, and the oysters must be held for a minimum of 2 months (Guidance for inspection loc cit). This is a costly operation and there is a risk that the shellfish may be lost by storms or pilferage. Furthermore, no area of sea can be guaranteed to be free from viruses and other microorganisms, which means that relaying cannot guarantee that the level of norovirus has been reduced to a safe level. Relaying is seldom performed in the UK.

### SUMMARY OF PROBLEM

The risk of norovirus food poisoning from oysters is so great that EFSA (European Food Safety Authority) commissioned an in-depth scientific study of norovirus in oysters and methods to reduce the risk. This study (EFSA Panel on Biological Hazards (BIOHAZ). Norovirus (NoV) in oysters: methods, limits and control options. EFSA Journal 2012; 10(1):2500) concluded that there is currently no method of reducing norovirus levels in oysters to a safe level that does not result in the death of the oysters and unacceptable changes to taste, texture and appearance.

Of the 884 samples analysed by Lowther, only 1.1% contained >10000 copies/g, with the maximum from a Class B harvesting area being 21000 copies/g.

Currently there is no method to ensure that shellfish such as oysters, mussels, clams, cockles, etc are free from viruses such as norovirus Almost all shellfish harvested in the UK has to be depurated before it can be placed on the market. Current depuration processes remove 93% of sewage borne bacteria but only 7% of sewage borne viruses. Lowther et al showed that over 75% of oysters harvested in the UK are contaminated with norovirus, with this level increasing to 90% during the winter months when most oysters are consumed. The average level of norovirus is about 500 RNA copies/gram in winter, which represents a significant risk of illness to people consuming such oysters raw or lightly cooked. Norovirus is highly infectious and causes “winter vomiting disease”, a form of gastroenteritis characterised by severe vomiting, diarrhoea and flu-like symptoms. It is the most frequent cause of food poisoning in the UK. Norovirus is relatively robust and shellfish that are eaten raw or only lightly cooked will be infectious. Other sewage-borne viruses such as hepatitis A & E, poliovirus, etc may also accumulate in shellfish. Consumption of raw shellfish such as oysters is known to carry a high risk of food poisoning and this restricts the market for such shellfish because people are not prepared to take the risk.

According to the present invention there is provided a method and/or facility according to the independent claims.

The main application of this invention will be to purify shellfish that are eaten raw or lightly cooked. For example, oysters are normally eaten raw and the invention applies to all varieties of oyster including, but not limited to: Ostrea edulis, Ostrea angasi, Ostrea lurida, Crassostrea gigas, Crassostrea sikamea, Crassostrea virginica, Saccostrea commercialis. Other shellfish such as mussels, scallops and clams may be eaten raw but are normally lightly cooked. Nevertheless, the brief cooking time necessary to preserve the taste and texture of the shellfish may be insufficient to ensure safety and this invention may also be applied with advantage to such shellfish.

Generally for each embodiment, the molluscs may be held in several types of container, whether a natural lagoon or lake (whether or not modified by human intervention), excavated reservoirs, tanks and containers of any suitable volume, but in all cases these are to be bodies of water separated from the sea, or whose communication with the sea can be controlled. Where a separate decontamination stage is used, again, the contaminated water can be held in natural lagoons (whether or not modified by human intervention), excavated reservoirs, tanks and containers of any suitable volume, and again in all cases these are to be bodies of water separated from the sea, or whose communication with the sea is controlled.

All reference to log reduction value are based on log(10).

The invention will now be described by way of example, and with reference to the figures, of which

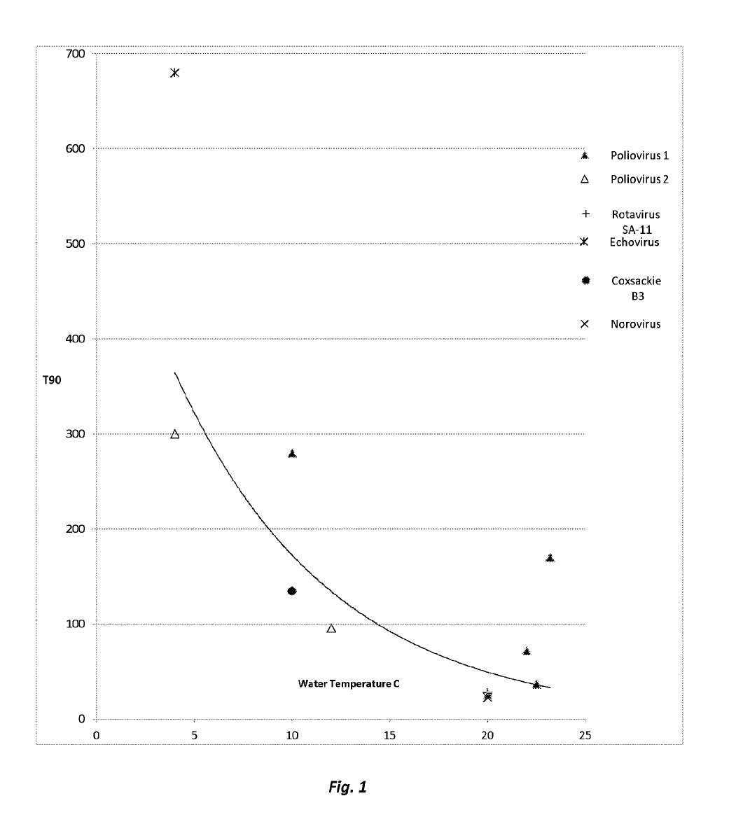

FIG. 1 shows a graph illustrating the reduction of enteroviruses in seawater with the action of sunlight,

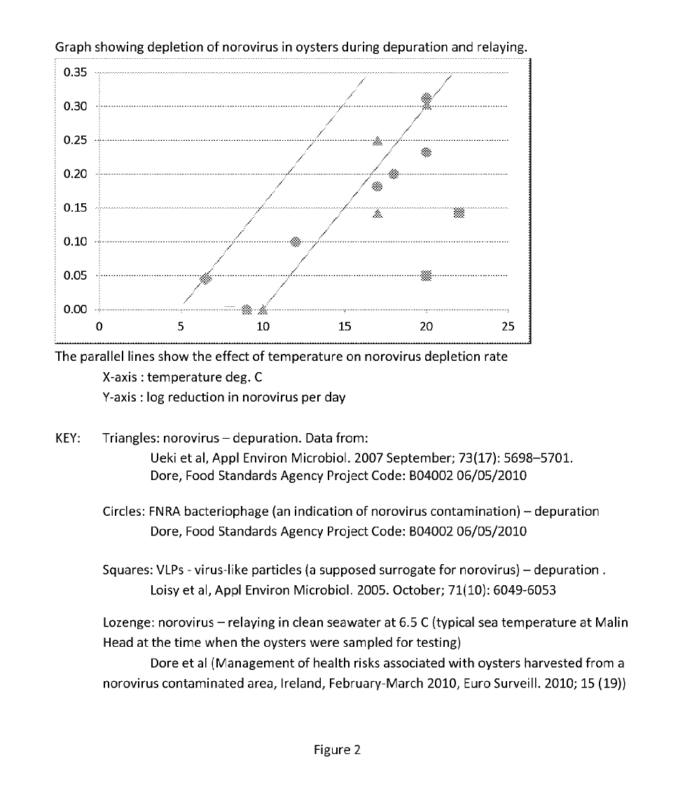

FIG. 2 shows a graph illustrating the reduction of viruses in seawater in the absence of sunlight, and

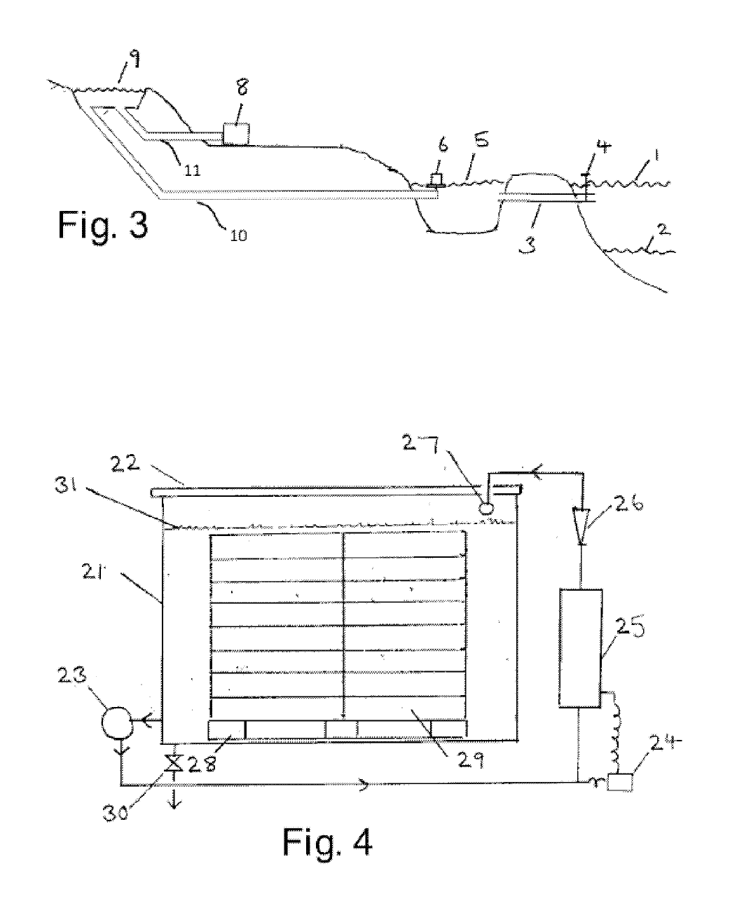

FIGS. 3 and 4 show diagrammatic representations of the system.

### SEAWATER DECONTAMINATION STEP

The container is supplied with clean saline water that is free from norovirus. This may be obtained from a number of sources, including: seawater that has been treated by ultra-violet light or ozone (as for conventional depuration) or by heating or by other suitable means to remove microbial contamination; seawater from a location that is known to be free from sewage contamination; clean saline water from a borehole or other source; fresh water from a borehole or other source, including a mains water supply, to which has been added sufficient salt to be suitable for the shellfish in question. Alternatively, seawater that may be contaminated can be purified by natural processes as described below, which may an economical option.

Referring to FIG. 3, a suitable tank is formed by excavating a reservoir 5 from the ground, which, depending on ground conditions, may need to be lined with butyl rubber or other impermeable lining. The volume of the reservoir 5 should be sufficient to supply a purification tank (which is described below) with sufficient daily water for a period of 6 weeks. However, supplying a larger capacity reservoir will be advantageous, since this will allow for wastage and future expansion of the facility, especially as the incremental cost of digging a bigger hole in the ground is comparatively small. The reservoir 5 should ideally be no more than about 3 metres deep, and uncovered.

The reservoir 5 is situated inland and excavated so that its base is beneath high tide sea level 1, and ideally about 3 metres beneath high tide sea level. It is also situated with a sufficient barrier of material (natural or artificial) that it is not inundated, for example by high spring tides.

A pipe 3 provides fluid communication between the reservoir 5 and the sea. The pipe lies at a level a little below high tide 1, and includes a non-return valve such as a flap valve. The level of the reservoir 5 is thus maintained at high tide level 1.

The seawater is held in the reservoir for sufficient time for viruses and bacteria derived from sewage contamination to be removed by the following natural processes. A typical time period sufficient for this will be 6 weeks.

During this time, several processes act to remove bacteria and viruses from the water. A first process is sedimentation. Viruses and bacteria adhere to suspended solids in the seawater that settle to the bottom and are thereby removed from the water itself. A second process is the action of sunlight. Both in the visible and UV light in sunlight deactivate viruses and bacteria. A third process is the predatory action of naturally occurring marine microorganisms such as protozoa and bacteria on sewage borne bacteria and viruses. In addition to these processes, the salinity of the seawater and other environmental factors act to reduce the number of bacteria and viruses in the water.

While the water is decontaminated of sewage-borne bacteria and viruses, the water is not sterile. It still includes naturally occurring plankton, such as algae, protozoa, and bacteria adapted to the marine environment.

Decontaminated water is fed by a high capacity submersible pump 6, suitable for seawater, from the reservoir 5 to a supply reservoir 9 through pipework 10. The pump 6 is attached to a floating raft, so that it draws sediment-free water from the upper layer of the water and without increasing turbidity and disturbing the sediment. The supply reservoir is then used to supply the following depuration process through a gravity feed through pipework 11.

The supply reservoir makes providing the oysters with decontaminated water more convenient, but it would also be possible to supply the oysters directly from the decontamination reservoir. Equally, it would be possible to situate the decontamination reservoir at a higher level, and supply all the seawater by pump, which would negate the need for a separate supply reservoir.

Depuration Step

This invention may be applied to any of the conventional depuration systems currently in use. For new installations the following may be an economical option.

Oysters are placed in a container 8, which is supplied by decontaminated water by the supply reservoir 9 through pipework 11, or from another source as described above. Referring to FIG. 4, a number of oysters are placed in perforated stackable containers 29. The number of oysters each container can hold may be specified by regulations, e.g. for the EU, the CEFAS depuration specification the volume and depth of water in a container sufficient for a given number of oysters. For example, a 600×400×150 mm container can hold 125 oysters. Several containers are prepared this way. 48 such containers would house 6000 oysters.

The containers are placed on a pallet 28, which is transferred to a water tank 21. The tank should be suitable for seawater and preferably insulated, for example a double-wall insulated GRP (Glass Reinforced Plastic) water tank. The volume of the tank is preferably greater than 2500 litres (again, the CEFAS regulations specify a minimum volume for given number of oysters). The water tank is covered with a transparent lid, made for example from multi-wall polycarbonate, which has good insulating properties.

As previously explained, decontaminated water is supplied to the GRP tank by gravity feed via a control valve from the upper reservoir

Water is then continuously drawn from the GRP tank 21 by a recirculation pump 23, heated by an in-line immersion heater 25, and returned to the tank via a spray bar 27, at a rate sufficient to comply with CEFAS regulations (a flowmeter 26 may be provided in-line with the recirculation pump to monitor the recirculation). A thermostat 24 is provided in the tank to monitor the water temperature and control the immersion heater.

The time required for the oysters to become decontaminated depends on the water temperature and the availability of food. A temperature of 15-20° C. is likely to be optimal in most situations and at this temperature a 4×log reduction in norovirus contamination of the oysters will occur within about 6 days provided that the oysters are feeding freely.

Sewage borne bacteria are eliminated more quickly than norovirus. This means that the oysters, no matter how severely contaminated, will be safe to eat without the need for testing.

Although a 4×log reduction will ensure safety for even the most heavily contaminated oysters identified in the survey by Lowther, a lower log reduction may be selected for fisheries where the level of contamination is known to be lower. This gives a proportionate reduction in the time for purification.

The provision of the heating means is likely to be economically advantageous, especially in colder climates, but in warmer climates may not be necessary. Further, the oysters may be held at a lower temperature provided the holding time is increased. Some species of oysters, for example C. gigas, can grow at temperatures considerably higher than 20° C., which may increase the rate of feeding and, hence, depuration. This may be advantageous in warm climates or where heating costs are low.

Food is provided to the oysters by one of more of the following means, either singly or in combination. Where the water contains little or no phytoplankton or other food source, for example if it has been purified by ultra-violet light or ozone or has been obtained from a borehole or by adding salt to fresh water, it will be necessary to supply food (Option 1). A suitable food is either a proprietary shellfish food or phytoplankton cultured in a separate facility. The technology for phytoplankton culture is well known.

The advantage of this option is that the supply of food can be optimised and controlled, thereby ensuring the desired log reduction in norovirus. A feed rate of 3% of the meat weight of the oysters at 15 to 20° C. will give a reduction of 0.7 logs per day.

When the water is seawater that has been decontaminated by natural processes as described above or is from contamination-free seawater, the seawater will contain naturally-occurring phytoplankton and the shellfish may be fed from this source by supplying the depuration facility with a controlled supply of this seawater (Option 2).

The advantage of this option is that it avoids the cost of feeding the oysters, but the depuration time to achieve the desired log reduction may be longer. Furthermore the volume of seawater that may need to be heated may be greater, increasing heating costs if the water from the reservoir is cold.

It may be that the most economical solution is to feed according to Option 2 in the summer when the seawater is warm and contains plentiful phytoplankton and to feed according to Option 1 in the winter when the seawater is cold and the phytoplankton population comparatively low.

Facility Set-Up and Batch Operation

Several depuration tanks as previously described may be provided, the operation of each commencing in turn at intervals to provide a staggered, continual supply of oysters in a batch process. If the seawater is being decontaminated in a reservoir, this will necessitate a larger decontamination reservoir, with a capacity of at least 6 weeks continual seawater usage by the facility.

The decontamination of the seawater may itself be operated in a batch process. For example, two reservoirs similar to that previously described, but each having a capacity of 300,000 litres, could be used to comfortably supply 10 previously described depuration tanks.

Discussion of Scope and Variations

Decontaminating the seawater before using the decontaminated seawater to depurate the shellfish allows the depuration to take place quickly, safely and in compliance with existing regulations concerning depurating oysters in using clean water. It is also possible though to decontaminate the seawater with the oysters concurrently, using a single reservoir or tank. There are disadvantages with such an approach, in particular the oysters may initially still be feeding in contaminated water, so a greater time will be needed to ensure the oysters have been feeding in decontaminated seawater.

The process is particularly suited to oysters, which particularly accumulate sewage-borne viruses, and are often eaten raw or lightly cooked. Other bivalve molluscs such as mussels and clams have also been found to accumulate sewage-borne viruses, and this method is equally applicable.

The time period necessary for decontamination of the seawater will be the same, 6 weeks in the winter, less in the summer depending on the seawater temperature. FIG. 2 gives the relationship between water temperature and decontamination time.

The time period in which the shellfish are held in the decontaminated water may be varied according to the species, depending on the rate by which it is found viruses are expelled from the shellfish. As for oysters, the rate will also depend on factors such as temperature, and the original level of contamination.

A report by Vilariño et al (Vilariño et al, Assessment of human enteric viruses in cultured and wild bivalve molluscs, International Microbiology, 2009, 12:145-151) shows that mussels, cockles and clams accumulate norovirus particles at similar levels to those observed in oysters. This suggests that the mechanisms that cause the accumulation and elimination of norovirus from these various species of bivalve mollusc are similar and it is reasonable to assume that the depuration conditions and rate of elimination specified for oysters in this invention will also apply to other bivalve molluscs.

While it is more cost-effective to use an excavated reservoir to decontaminate the large volume of seawater, free-standing containers could of course be used. Similarly, use of a lidded container allows for more efficient heating, and prevents contamination from birds or animals, but in some environments the oysters could be depurated in an excavated reservoir.

### ADVANTAGES DISCUSSED

The processes described above are completely natural and involve no chemicals or artificial processes. The processes involve comparatively low capital expenditure and are well within the scope of a fishery operation. Where the food source is naturally-occurring phytoplankton, operating costs are minimal. Even if feeding is required, the on-cost is small compared with the economic benefit of norovirus-free shellfish.

As previously mentioned, the harvesting and marketing of Live Bivalve Molluscs in the EC is proscribed, specifically is controlled by Regulation EC/853/2004—Section VII. Shellfish can only be placed on the market without purification if they are harvested from Class A waters, of which there are very few in the UK. Accordingly, most, if not all, oyster fisheries will already have a depuration facility.

Using this invention means that fisheries will be able to guarantee that their shellfish is free from viruses, and thereby command a substantial premium. Installation of this invention in addition to depuration can be done without legal restriction or the need for regulatory approval.

This invention, however, eliminates both viruses and bacteria and can be used to replace depuration. This is likely to be economically advantageous but it means that the installation has to comply with Regulation EC/853/2004—Section VII and be approved by the competent authority (CEFAS in the UK). The detailed specification of a shellfish purification facility based on this invention complies with the CEFAS (the DeFRA department dealing with fisheries) protocol for depuration and, subject to approval by CEFAS, will enable the replacement of conventional depuration.

Explanation

There are two separate mechanism decontamination mechanisms which are utilised in this method, and these two methods work synergistically.

Firstly, harmful, sewage borne bacteria and viruses are removed by from seawater by the processes described above. Secondly, the shellfish are permitted to feed normally in the decontaminated seawater. The various data and studies set out below indicate that the action of feeding causes shellfish to eliminate viruses much more readily than shellfish in sterile saline water. This finding has been confirmed by the appended results of a series of experiments that confirm this hypothesis.

Explanation of Decontamination of Seawater

Sewage borne viruses and bacteria are alien to the marine environment. They are not present in uncontaminated seawater and are not adapted to survive or multiply in natural seawater. They are quickly eliminated by natural processes including the effect of sunlight and predation by other microorganisms naturally occurring in seawater.

If seawater is isolated such that it is no longer being contaminated by sewage, virus and bacteria levels reduce with time. Scientific research shows that survival of norovirus in seawater is dependent on the water temperature and the amount of exposure to sunlight. One measure of the rate of survival is the time for 90% of the viable virus to be inactivated (T90)—this is the same as a 1 log reduction.

Table 1, the T90 for different enterovirus strains in marine waters is shown at a range of temperatures, with exposure to sunlight (FIG. 1 shows a plot of these values, together with a regression curve of best fit). Table 2 gives the same information for marine waters in the absence of sunlight. These data are derived from Table 1 in the “Opinion of the Scientific Committee on Veterinary Measures Relating to Public Health on Norwalk-like Viruses” (EFSA report: Opinion of the Scientific Committee on Veterinary Measures Relating to Public Health on Norwalk-like Viruses, January 2002) and the report by Dr Henshilwood, “The Survival of Norwalk-like Viruses and Potential Viral Indicators in Sewage Treatment Processes and the Marine Environment” (Henshilwood et al, “The Survival of Norwalk-like Viruses and Potential Viral Indicators in Sewage Treatment Processes and the Marine Environment”, UK Food Standards Agency, April 2004). The graph displayed in FIG. 1 presents the data in Table 1 in graphical form. The line is a best-fit curve for all the data points and it shows that the T90 decreases with increasing water temperature.

TABLE 1
T90 of different Enterovirus strains with exposure to sunlight

| | Water | | |
|---|---|---|---|
| Virus type | temperature C. | T90 hours | Reference |
| Poliovirus 1 | 10 | 280 | Lo et al 1976 |
| Poliovirus 1 | 23.2 | 170 | Lo et al 1976 |
| Poliovirus 1 | 22.5 | 37 | Akin et al 1976 |
| Poliovirus 2 | 4 | >288 | Bitton 1978 |
| Poliovirus 2 | 12 | 96 | Bitton 1978 |
| Poliovirus 2 | 22 | 72 | Bitton 1978 |
| Rotavirus SA-11 | 20 | 28 | Hurst and Gerba |
| | | | 1980 |
| Echovirus 6 | 4 | 680 | Bitton 1978 |
| Echovirus 7 | 20 | 26 | Hurst and Gerba |
| | | | 1980 |
| Coxsackie B3 | 10 | 135 | Hurst and Gerba |
| | | | 1980 |
| Norovirus | 20 | 23 | Henshilwood |
| | | | 2002 |
| Poliovirus 1 | 20 | 27 | Henshilwood |
| | | | 2002 |

TABLE 2
T90 of different Enterovirus strains with no exposure to sunlight

| | Water | | |
|---|---|---|---|
| Virus type | temperature C. | T90 hours | Reference |
| Rotavirus SA-11 | 20 | 85 | Rao et al 1984 |
| Norovirus | 20 | 78 | Henshilwood |
| | | | 2002 |
| Poliovirus 1 | 20 | 32 | Henshilwood |
| | | | 2002 |

A review of enterovirus monitoring data for UK coastal waters for 1988 to 1992 showed that 31% of samples examined for viruses were positive with total enterovirus levels ranging from 1 to >1400 pfu per 10 litres (Opinion of the Scientific Committee on Veterinary Measures Related to Public Health on Norwalk-like Viruses, EFSA 2002. Page 16). Based on this, a 3 log reduction in total enterovirus counts will effectively decontaminate the seawater with respect to norovirus and this can be achieved by a holding time in the reservoir of 6 weeks, even under adverse winter conditions. This time will be shorter in the summer.

Bacteria are much more vulnerable than viruses and sewage-borne bacteria will also be eliminated—this is confirmed by a number of scientific studies of the inactivation of E. coli and other sewage borne bacteria in seawater (see e.g. Mitchell et al, Lysis of E. coli by marine microorganisms, Nature 215, 891-893 (19 Aug. 1967), and Fujioka et al, Effect of sunlight of survival of indicator bacteria in seawater, Applied and Environmental Microbiology, March 1981, p. 690-696 Vol. 41, No. 3).

Explanation of Depuration in Decontaminated Seawater

The presence of microflora in the seawater allows the shellfish to feed normally. Shellfish do not feed normally in sterile water such as that in a conventional depuration system (there is nothing for them to feed on) and the digestive processes within the shellfish that deactivate or expel viruses do not function.

It has been shown that norovirus particles bind to specific binding sites on cells in the oyster digestive tract, where the norovirus is concentrated (Le Guyader et al, Norwalk virus specific binding to oyster digestive tissue, Emerg Infect Dis. 2006 June; 12(6): 931-936.).

I believe that a highly plausible explanation is that the existence of an active mechanism in oysters to deactivate virus particles is an evolutionary imperative. Oysters survive by filtering microorganisms, including viruses, from seawater. They are constantly exposed to microorganisms and will have evolved defences. Oysters live with no apparent ill-effect in seawater heavily contaminated with human sewage. As viruses, such as norovirus, in the sewage bind to cells within the digestive gland of the oyster there must be mechanisms to reverse this binding to prevent these cells being overwhelmed by viruses. As the binding sites are in the digestive gland it is reasonable to suppose that the mechanisms are focussed on the digestive gland.

Research by Dore (Dore et al, Management of health risks associated with oysters harvested from a norovirus contaminated area, Ireland, February-March 2010, Euro Surveill. 2010; 15 (19)) shows that when oysters contaminated by an outfall of sewage were relaid in clean seawater at 6.5 C, norovirus levels fell from 2900 to 492 copies/g in 17 days, (cf no depletion <10° C. in UV-treated water)

I believe that it is highly likely that, for depletion to take place, the oysters must be feeding normally with their digestive system active. During conventional depuration, the oysters are immersed in seawater that has been sterilised by UV light (UK) or ozone (France) and none of the microorganisms on which oysters feed are present. The digestive system will be inactive and no depletion occurs. By contrast, in ordinary seawater even at low temperatures, oysters continue to feed and the processes within the digestive gland continue to operate.

The graph in FIG. 2 shows the rate of depletion of norovirus and norovirus surrogates in oysters in various situations. There is a good correlation between temperature and the rates of depletion of norovirus (triangles) and bacteriophage (circles) during depuration—as shown by the right-hand line.

The outliers on the graph in FIG. 2 are:
Virus-like particles (VLPs). These are comprised of multiple copies of a protein antigen that, when assembled together, mimic the conformation of norovirus. They replicate the protein shell that coats a virus, called the “capsid”. The norovirus VLPs bind to cells in the digestive tract of the oyster in the same way as norovirus but it is clear from the graph that they are not deactivated in the same way.
Norovirus in oysters relayed in clean seawater. The same underlying mechanism is utilised by the invention, although the invention guarantees norovirus-free seawater whereas the seawater in the Dore et al research was not tested and only supposed to be clean because it was remote from the contaminated site.

It is unfortunate that only one data point for relaying has been located. Nevertheless, it shows that in oysters feeding normally deactivation of norovirus occurs at low temperatures and, if the same temperature effect is assumed as for depuration, a 4 log reduction would be predicted to occur in 12 days at a temperature of 16 C (left-hand line). The results of the experiments (presented below) testing this invention confirm that the rate of reduction of norovirus is determined by the rate of consumption of food and that, for oysters supplied with 3% of their meat weight per day at 19° C., a 4 log reduction will occur in 6 days.

Bacteria do not bind to cells and are quickly expelled from the digestive tract. In depuration, this takes place within 42 hours and the same will apply to this invention.

A process that achieves a 4×log reduction in norovirus will eliminate norovirus from those typically on sale in the UK, with a high safety margin, and reduce the level in the most heavily contaminated oysters to no more than 2 copies per gram. These levels represent no risk to consumers and are below the level of detection by current analytical techniques, including PCR (polymerase chain reaction). This invention will deliver a 4 log reduction in norovirus. The depuration time can be adjusted for any desired log reduction.

A further safety factor is that the current most sensitive technique for detecting and quantifying norovirus is PCR. This detects virus DNA but cannot distinguish between viable (infectious) virus particles and DNA strands from viruses that have been deactivated. PCR, therefore, is likely to over-estimate the number of infective virus particles.

Le Guyader et al (Norwalk virus specific binding to oyster digestive tissues, Emerg Infect Dic, 2006, 12(6): 931-936) identified that norovirus particles bind to cells in the digestive tract of oysters (C. gigas) via carbohydrate linkages similar to those that enable norovirus to bind to cells in the human gut. Norovirus does not replicate, or appear to cause harm in oysters.

Le Guyader states “Virus-mediated disease can be transmitted when contaminated shellfish are eaten. Oysters are believed to act as filters or ionic traps, passively concentrating particles. A simple depuration process should be sufficient to rid oysters of virus, as observed for bacteria. However, long-term virus persistence in shellfish is a serious public health issue, and depuration or relaying is known to be inefficient. After bioaccumulation, only 7% of Norwalk virus is depurated, compared to a 95% reduction in bacterial levels. Virus is located mainly in pancreatic tissue (digestive diverticula), and various mechanisms have been suggested to explain differences between oyster species regarding virus accumulation, such as mechanical entrapment or ionic bonding. Our data demonstrate specific binding of viral particles from a genogroup I norovirus to the oyster digestive tract and suggest a specific mechanism for concentration of virus particles. We tested recombinant VLPs of prototype genogroup I Norwalk virus. VLPs are stable in the marine environment and the disinfection processes. Bioaccumulation and tissue-binding experiments showed no difference between native Norwalk virus and VLPs, which confirmed that VLPs are good surrogates of infectious virions.”

Le Guyader goes on to explain and hypothise that “Different results were seen between bioaccumulation experiments and particle binding to tissues sections. After bioaccumulation, some viral particles were detected in phagocytes in either epithelium or connective tissue. This finding could reflect elimination of virus during digestion. The time required for food to pass through the entire shellfish intestinal tract varies from 90 to 150 min. We do not know whether immunoreactive material detected in phagocytes corresponds to particle degradation and digestion or if particles can escape digestion. Binding to main ducts may provide a mechanism for viral particles to avoid entering the digestive system and being degraded. Specific attachment of virus to oyster cells and capture by phagocytes may explain why depuration in oysters is not an effective mechanism for eliminating virus.”

Galtsoff (1964), Organs of digestion and food of the oyster. (www.nefsc.noaa.gov/publications/classics/galtsoff1964/chap10.pdf) published a detailed account of the anatomy and functioning of the oysters' digestive system. It is highly complex system with a large number of elements conducting different functions. Two findings of particular relevance to this invention are:

1. Phagocytes play an important role in the digestion of large algae such as diatoms.

2. High levels of phagocytes are present in the stomach and digestive diverticulum.

The digestive diverticulum, also known as the pancreas or hepatopancreas, surrounds the stomach and plays an important role in the absorption of nutrients. As identified by Le Guyader, norovirus particles are accumulated mainly in the digestive diverticulum.

Phagocytes are cells that play an important role in the immune system. They are specifically adapted to engulf, kill and absorb waste material, harmful microorganisms, or other foreign bodies. It appears that, in oysters, phagocytes have a dual role: digesting diatoms and engulfing microorganisms such as norovirus, as identified by Le Guyader.

As with most animals, the functioning of the oysters' digestive system (generation of enzymes, mobilisation of phagocytes, etc) is stimulated by the ingestion of food. This explains why conventional depuration is ineffective at eliminating norovirus. There is no food to ingest in the sterile water in the depuration system and the mechanisms that eliminate viruses in the gut are not active. In this invention, however, food is available and the mechanisms are activated.

Artificial Feeding

It will be realised that the principles of the inventive aspects disclosed herein could be applied with various modifications. In particular, uncontaminated salt water, whether from seawater, brackish water, or water to which salt has been added, together with suitable artificial feed could be substituted for the decontaminated seawater described above.

Artificial feeding of shellfish is currently only practiced for feeding brood shellfish and their offspring at fisheries producing young shellfish (spat) which are then transferred to coastal waters. Long term artificial feeding is unlikely to be economical or necessary; however for the comparatively short periods of the herein described depuration process it is feasible to supplement or entirely meet the oyster's diet with artificial food, and thus reduce the volume of water used in, or entirely dispense with, the decontamination step.

Oysters feed mainly on phytoplankton. In natural seawater with a wide range of phytoplankton, diatoms form the major part of the nutrient intake. Suitable artificial food for shellfish comprises concentrated phytoplankton, fed either as a suspension of inactivated phytoplankton or as live phytoplankton cultured under controlled conditions at the fishery.

In oysters, phagocytes play an important role in the digestive process. Larger phytoplankton, such as diatoms, are engulfed and digested by phagocytes in the gut. Norovirus accumulates in the digestive organs of oysters, mainly in the digestive diverticulum. High levels of phagocytes have been observed within the tissues of these digestive organs. Phagocytes containing engulfed norovirus particles have been observed in the digestive diverticulum.

The research suggests that norovirus is eliminated more efficiently from oysters that are feeding than those that are held in the sterile water of a conventional depuration system. The information summarised provides a probable explanation for this—ingestion of food stimulates the release of phagocytes that engulf and destroy the norovirus particles bound to the surface of cells in the digestive organs.

While it is possible that the intake of larger phytoplankton, such as diatoms, is necessary to stimulate the release of phagocytes, it is also possible that the intake of any food is sufficient. In any case, oysters may be supplied with a dose of a concentrated suspension of deactivated diatoms at regular intervals, eg. twice daily, or continuously via a metering pump. “Shellfish 1800” is such a feed. A holding tank containing 6000 oysters would require approximately 3 litres a day of Shellfish 1800. Although this represents an additional cost to the depuration process, the additional cost is not prohibitive (£0.015 per oyster per day). Furthermore, it may then be possible to dispense with or reduce the decontamination reservoir, by simply adding artificial feed and any required salts to uncontaminated or sterile water.

Artificial feeding, therefore, consists of supplying the shellfish with marine phytoplankton. “Shellfish Diet 1800” (Reed Mariculture Inc) is an example of a concentrated suspension of inactivated phytoplankton for feeding oysters and other shellfish. It contains 2 billion organisms per ml of suspension. Cost about £25 per litre. Alternatively phytoplankton can be cultured at the shellfish fishery, which is known technology using sterilised seawater, live cultures of the desired phytoplankton, chemical nutrients, etc.

The costs involved in the artificial feeding of shellfish mean that it is used only for facilities producing “spat” (young shellfish). In these facilities, the adult brood oysters and the resulting offspring are fed artificially under carefully controlled conditions. Once the spat are of a sufficient size, they are then placed into coastal waters to grow naturally in the sea to a 0 size, which takes about 1 to 2 years. Artificial feeding of shellfish prior to harvesting or after harvesting is not currently used.

An important aspect of the invention is that the shellfish feed normally and that suitable food is available throughout the holding time for decontamination. Artificial feeding with Shellfish 1800 or other suitable food is an economic option for the comparatively short period of time required to achieve the desired reduction in viral contamination of the shellfish.

Experimental Data

Experiments were carried out both to confirm the hypothesis that providing oysters with a diatom-based food or naturally-occurring marine phytoplankton at a temperature at which they are feeding actively results in the removal of norovirus from the oysters, and to investigate how varying the conditions can effect the process, with a view to optimizing the commercial method. The experimental method, and the results of the experiments are given below.

Experimental Method

Oysters were harvested from a B-classification harvesting area in the Colne estuary within 1 day of the start of each experiment. They were contaminated with faecal samples obtained from the PHE Laboratory in Colindale known to be contaminated with GI-7 and GII-4 strains of norovirus according to the method used by Neish at CEFAS for her extended depuration experiments (Neish A, loc cit).

For experiments using natural phytoplankton, a sample of 12 oysters was placed in a perforated plastic basket and immersed in 600 litres of seawater in an insulated plastic tank. The seawater was circulated through two 300 W thermostatically-controlled heaters to a spray bar at a rate of 1100 litres/hour for the duration of the experiment. For experiments with artificial feeding, a sample of 10 oysters was immersed in 15 litres of water in a 50 litre plastic tank with water circulation through a single 300 W thermostatically-controlled heater at a rate of 200 litres/hour for the duration of the experiment. For artificial feeding, the feed was administered to the oysters twice a day. The volume of feed was dispensed from a calibrated medical syringe and dispersed in 300 ml of seawater before being added to the tank of oysters.

Samples of oysters pre- and post-depuration were then analysed for norovirus by the laboratory at CEFAS, Weymouth. This is the European reference laboratory for this analysis. Note that CEFAS state that there is a +/−0.17 log margin of error for each analysis. CEFAS also measured the shucked and drained meat weight of each sample of oysters to determine the % feed rate.

Results of Experiment

The “base-line” result for comparison with the results of the experiments is the research by Anna Neish at CEFAS (loc cit) that measured the log reduction in norovirus in faecally-contaminated oysters as 0.23 following 14 days depuration in UV-sterilised seawater at 16° C. (59% of the norovirus still remaining). No reduction was measured during 14 days at 8° C.

Based on the results of the experiments listed below, if the oysters in Anna Neish's experiment had been fed with a diatom-based feed at the optimum rate of 3% of oyster meat weight per day, there would have been a 10 log reduction in norovirus over 14 days.

Comparison of Reductions for GI and GII Strains

The table below lists the paired log reductions for GI and GII for the experiments.

| Date of experiment | Log red'n GI | Log red'n GII |
|---|---|---|
| 14 Jan. 2014 | 1.32 | 1.38 |
| (natural phytoplankton 19° C., 14 days) | | |
| 28 Jan. 2014 | 1.38 | 1.25 |
| (natural phytoplankton 24° C., 14 days) | | |
| 18 Feb. 2014 | 0.22 | 0.14 |
| (artificial feeding 0.6%/day @24° C., 2 days) | | |
| 18 Feb. 2014 | 1.37 | 1.56 |
| (artificial feeding 3%/day @24° C., 2 days) | | |
| 18 Feb. 2014 | 1.43 | 1.28 |
| (artificial feeding 3%/day @19 C., 2 days) | | |
| 4 Mar. 2014 | 0.45 | 0.59 |
| (artificial feeding 4.3%/day @19 C., 1 day) | | |
| Average log reductions for GI and GII | 1.03 | 1.03 |

This confirms that the reductions in GI and GII are identical, which would be predicted by the phagocyte-ingestion hypothesis (phagocytes are unlikely to discriminate between the two strains). The remarkable co-incidence of the GI and GII reductions gives credence to the integrity of the experiments and the analyses.

Comparison of Artificially and Naturally Contaminated Oysters

The experiments on 14.1.14 and 28.1.14 were done with oysters artificially contaminated with faecal samples and oysters immersed next to the outlet of Brightlingsea sewage works for 19 days, respectively. The similarity in the log reduction results confirms that both contamination techniques are valid and give similar results. Although one experiment was done at 19° C. and the other at 24° C., the result below indicate that effect of the difference in temperature is relatively small.

Effect of Temperature

The experiment on 18.2.14 gave a log reduction in total norovirus of 1.50 following 2 days feeding at 3% at 24° C. and 1.32 following 2 days feeding at 3% at 19° C. The difference between 1.50 and 1.32 is not significant, especially bearing in mind the error bars on the analysis. This means that the rate of feeding is the primary determinant of the rate of reduction in norovirus, although increasing the temperature may have a small positive effect.

Effect of Feed Rate

The total norovirus log reductions per 1% of meat weight ingested as food are as follows: Feed rate/day Log reduction per 1% meat weight of food

| | |
|---|---|
| 0.6% @ 24° C. | 0.13 |
| 3% @ 24° C. | 0.25 |
| 3% @ 19° C. | 0.22 |
| 4.3% @ 19° C. | 0.12 |

The optimum at about 3% of meat weight fed per day as two divided doses can be explained as follows. Phagocytes have a role in the digestion of diatoms by engulfing the organism and extracting its contents. They also ingest norovirus particles. It is assumed that a phagocyte will engulf the first microorganism it encounters, either norovirus or diatom. It is hypothesised that the activation of phagocytes is stimulated by the ingestion of food and it is likely that this activation will follow a standard S-shaped dose-response curve. This is analogous to the secretion of insulin in humans in response to the ingestion of glucose—which has the typical S-shaped curve.

At a low feed rate, there is little activation of phagocytes and comparatively little removal of norovirus. If food is in excess, such that the rate of activation of phagocytes moves into the flat part of the dose-response curve, there is no increase in the activation of phagocytes and the excess food means that the probability that the phagocyte will encounter a diatom, as opposed to a norovirus, is increased. As a result, the rate of norovirus removal decreases. In the light of this finding, it may be possible to increase the rate of removal at a given feed rate by continuously feeding the oysters via a metering pump. This has not been tested.

### SUMMARY

In summary then, at 19° C., a feed rate of 3% of the meat weight of a shucked and drained oyster per day is optimal and this gives a reduction in norovirus of 0.7 logs per day, which is equivalent to 0.24 logs per 1% of feed. This compares with the prediction of 0.4 logs per day at 19° C., from the hypothesis. The improved rate of reduction determined by the experiments almost certainly results from feed rate being optimal. Feed rates from 0.6% to 4.3% of meat weight per day were measured by the experiments.

The existence of an optimum feed rate is consistent with a standard dose-response curve for the hypothesised activation of phagocytes in response to food. Insufficient food results in sub-optimal activation of phagocytes. Excess food results in no increase in the number of phagocytes (the flat part of the dose-response curve) but the excess of food increases the probability that a phagocyte will encounter and engulf a food particle rather than a norovirus particle. This reduces the rate of removal of norovirus.

At a given feed rate, varying the temperature has little effect on the rate of reduction of norovirus provided that the oysters are feeding actively. Increasing the temperature increases the rate at which oysters feed and a temperature of about 19° C. is required to enable oysters to ingest 3% of their meat weight per day. The experiments also measured the effect of increasing the temperature to 24° C. This did not significantly increase the rate of reduction at a given feed rate but an elevated temperature is likely to increase the ability of oysters to ingest feed, thereby permitting higher feed rates and increasing the rate of reduction per day. The optimum temperature will be an economic trade-off between the heating cost and the capital cost of the depuration equipment.

The experiments have confirmed that the rates of reduction of the GI and GII genotypes are identical. This indicates that the invention will work for all GI and GII norovirus strains, which are the strains that infect humans.

The experiments have confirmed that there is no difference in norovirus-reduction between oysters artificially contaminated by exposure to norovirus-contaminated faeces and oysters naturally contaminated by exposure to sewage-contaminated seawater.

The experiments have confirmed that norovirus-reduction is achieved regardless of whether the food consists of a proprietary shellfish food or naturally-occurring phytoplankton in seawater.

The experiments confirm that the invention is a cost-effective post-harvest treatment for molluscan shellfish that enables the removal of norovirus from contaminated shellfish, whilst having no adverse effect on the quality of the shellfish. No other treatment is capable of achieving this.

Types of Food Suitable for the Invention

The experiments described below show that the invention is effective if the shellfish are supplied either with the wide range of plankton naturally-occurring in seawater or with Shellfish 1800. The latter contains the following species of plankton that have been deactivated: Isochrysis sp, Pavlova sp, Thalossiosira weissflogii, Tetraselmis sp. As the plankton in naturally-occurring in seawater is an effective food, it is likely that any feed based on plankton will also be effective, whether supplied from naturally-occurring seawater or by cultivating plankton in a separate facility or by a proprietary shellfish food.

It is possible that any food ingested by shellfish may also be effective. For example: food composed of or derived from any aquatic organism or from land-based animals or other organisms or from plant sources or from the products of biotechnology. It is possible that a completely artificial food composed of or derived from proteins, carbohydrates, fats, vitamins, minerals, etc may also be suitable.

Such options would need to be tested but have the potential to be an economic alternative to plankton, should they be effective.

1. A method of depurating shellfish, comprising the steps of:
taking decontaminated seawater, uncontaminated seawater, brackish water or water with sufficient salinity to support shellfish; and
holding the shellfish and the water in a container, lagoon or other body of water separate from the sea, and allowing the shellfish to feed, for a sufficient time for any viruses and bacteria to be expelled or deactivated.

2. A method according to claim 1, further comprising:
adding shellfish feed in the form of active or inactive phytoplankton or other substance on which shellfish may feed to the water.

3. A method according to claim 2, further comprising:
holding contaminated seawater in a container, lagoon or other body of water separate from the sea for a sufficient time for viruses and bacteria derived from sewage contamination to be removed by natural processes to produce decontaminated seawater.

4. A method according to claim 3, further comprising:
holding seawater in a first container, lagoon or other body of water separate from the sea while decontamination takes place, and holding the shellfish in a second container, lagoon or other body of water separate from the sea, the decontaminated water being transferred to the second container.

5. A method according to claim 4 wherein the decontaminated seawater temperature in raised to or held between 15-20° C.

6. A method according to claim 5, further comprising:
adding salt to raise the salinity of the water.

7. A shellfish depuration facility suitable for use according to claim 4, comprising
a first open-air container, lagoon or other body of water separate from the sea that receives water from the sea, and pump or other means for transferring said water from the sea to the reservoir; and
a second container, lagoon or other body of water separate from the sea for holding shellfish, and a means for transferring water from the first container, lagoon or other body of water separate from the sea to the second container, lagoon or other body of water separate from the sea.

8. A method according to claim 1, further comprising:
adding salt to raise the salinity of the water.

9. A method according to claim 1, further comprising:
holding seawater in a first container, lagoon or other body of water separate from the sea while decontamination takes place, and holding the shellfish in a second container, lagoon or other body of water separate from the sea, the decontaminated water being transferred to the second container.

10. A method according to claim 9, wherein the decontaminated seawater temperature in raised to or held between 15-20° C.

11. A method according to claim 1, further comprising:
holding contaminated seawater in a container, lagoon or other body of water separate from the sea for a sufficient time for viruses and bacteria derived from sewage contamination to be removed by natural processes to produce decontaminated seawater.

12. A method according to claim 11, further comprising:
holding seawater in a first container, lagoon or other body of water separate from the sea while decontamination takes place, and holding the shellfish in a second container, lagoon or other body of water separate from the sea, the decontaminated water being transferred to the second container.

13. A method according to claim 12, wherein the decontaminated seawater temperature in raised to or held between 15-20° C.

14. A method according to claim 11, further comprising:
adding salt to raise the salinity of the water.
